(19) United States
(12) Patent Application Publication
(10) Pub. No.: US 2009/0205728 A1
(43) Pub. Date: Aug. 20, 2009

(54) Disc Arrangement for Drilling or Production Choke or Valve

(75) Inventors: Paul R. Perez, Sugar Land, TX (US); Todd Travis, Humble, TX (US)

Correspondence Address: WONG, CABELLO, LUTSCH, RUTHERFORD & BRUCCULERI,;L.L.P., 20333 SH 249 6th Floor, HOUSTON, TX, 77070, US

(73) Assignee: WEATHERFORD/LAMB, INC., Houston, TX (US)

(21) Appl. No.: 12/033,602

(22) Filed: Feb. 19, 2008

(51) Int. Cl. F16K 3/08; F16K 47/08

(52) U.S. Cl. 137/625.3; 137/625.31; 251/212

(57) ABSTRACT

A flow adjusting apparatus having a pair of discs can be used for a drilling or production choke or valve. A stationary disc fixedly positions in a flow passage and defines at least one first bore permitting fluid flow. A rotatable disc positions in the flow passage between the stationary disc and the distal end of a stem. The rotatable disc defines at least one second bore permitting fluid flow. Rotation of the rotatable disc adjusts relative orientation between the first and second bores and adjusts fluid flow through the first and second bores. The stationary disc has a greater length than the rotatable disc to control exiting fluid flow beyond the discs and reduce erosion. In addition, the rotatable disc's bore defines a tapered relief at the disc's front face to control inlet of fluid flow and reduce erosion.

### BACKGROUND

Drilling chokes are used in several applications to control the flow of production medium or drilling fluids. For example, well control for circulating a “kick” or underbalanced and near balanced drilling applications often require the use of one or more drilling chokes to improve rig site safety. In addition, drilling chokes are useful for conventional well control issues involving exploration wells and drilling over-pressured zones, well testing operations and well clean ups which require flow control of the wellbore fluid to produce reliable test results. The typical drilling choke system includes a drilling choke 100A, such as illustrated in FIG. 1A, and a remote control console (not shown). Within the drilling choke's housing 110, two tungsten carbide discs 150/160 control fluid flow from the housing's inlet 112 to the choke's outlet spool 130.

The front and back discs 150/160 each have machined-through bores 152/162, respectively, and are positioned in holders 154/164. Drilling fluid passes through inlet 112 into the choke's housing 110 and passes a profiled throttling stem 120 holding the discs 150/160 together against a lower holder 164. The throttling stem 120 can be operated to rotate the front disc 150 relative to the stationary back disc 160, thereby determining the orifice size through the bores 152/162 and throttling fluid flow through the choke 100A.

The fluid throttled through the discs 150/160 can have abrasive materials such as rock, cuttings, sand, etc. and can have a high flow rate so that the fluid erodes the disc material. Moreover, the throttled fluid exiting the stationary back disc 160 forms a turbulent flow pattern that erodes the internal components of the outlet spool 130 beyond the discs 150/160 by cavitation and abrasion. The erosion can eventually lead to costly repairs and the need to replace components. Therefore, operators typical line the outlet spool 130 with a number of tungsten carbide sleeves 132 to handle erosion. These wear sleeves 132 can be costly and may need repeated replacement.

In alternative arrangements, a drilling or production choke 100B as in FIG. 1B can have a long cylindrical bean 180 downstream from the fixed disc 160 that extends into the outlet spool 130. The bean 180 can have a lined passage 182 for fluid flow that communicates with the bore in the fixed disc 160. In the drilling choke 100C in FIG. 1C also has a bean 180 extending from the fixed disc 160 with a fluid passage for communicating with the bore in the rotatable disc 150. This bean 180 in FIG. 1C fits into a specifically designed outlet spool 130 to accommodate the bean 180. The beans 180 in FIGS. 1B-1C can be difficult to manufacture and to replace and require a great deal of material. Moreover, the outlet spool used for such beans 180 may need to be particularly configured to house them, making the components less versatile. In fact, the drilling choke 100C in FIG. 1 C has an integral housing 110 and outlet spool 130 particularly configured for the bean 180.

### BRIEF DESCRIPTION OF THE DRAWINGS

FIG. 1A illustrates a cross-section of a drilling choke having discs according to the prior art.

FIG. 1B illustrates a cross-section of a drilling choke having discs and bean according to the prior art.

FIG. 1C illustrates a cross-section of another drilling choke having discs and bean according to the prior art.

FIG. 2 illustrates a cross-section of a drilling choke having a flow adjusting apparatus with front and back discs according to certain teachings of the present disclosure.

FIGS. 3A-3B illustrate cross-section and plan views of the front disc of FIG. 2.

FIGS. 4A-4B illustrate cross-section and plan views of the fixed back disc of FIG. 2.

### DETAILED DESCRIPTION

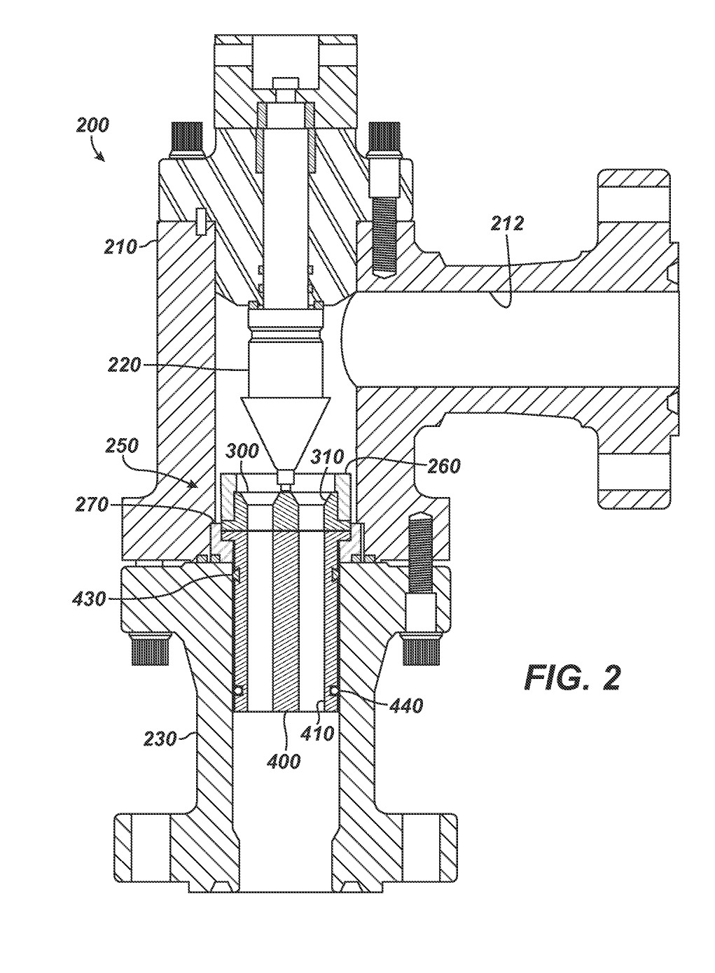

A drilling choke 200 illustrated in FIG. 2 has a flow adjusting apparatus 250 to adjust flow of drilling fluid through the choke 200. The flow adjusting apparatus 250 has front and back discs 300/400 that position in the choke housing 210 between the inlet 212 and the outlet spool 230. A profiled throttling stem 220 in the housing 210 positions against the rotatable front disc 300 in an upper holder 260. The back disc 400 positions between the front disc 300 and a lower holder 270 that holds the back disc 400 stationary in the housing 210.

The back disc 400 has an annulus seal 430 near its front face 402 and has an annulus trash seal 440 near its back face 404. These seals 430 and 440 engage the inner wall of the outlet spool 230. The annulus seal 430 can be a spring type seal having elastomer and metal springs and can be used to hold pressure around the disc 400. The annulus trash seal 440 can be an elastomer O-ring having polymer back up (par-bak) rings and can used to keep debris from fouling the seal area and caking between the disc 400 and spool 230.

Advantageously, the discs 300/400 can install in existing drilling choke or valve housings and outlet spools that use conventionally shaped discs without the need for specifically modifying the choke's housing or outlet spool to accommodate them. In particular, these discs 300/400 are shown in FIG. 2 used with the housing 210 having a uniformly cylindrical flow passage near its outlet where it connects to the outlet spool 230. Likewise, the discs 300/400 are shown using with an outlet spool 230 having a uniformly cylindrical flow passage near its connection to the housing 210. In this way, specifically designed or modified components are not necessary for a drilling or production choke 200 to use the disclosed discs 300/400.

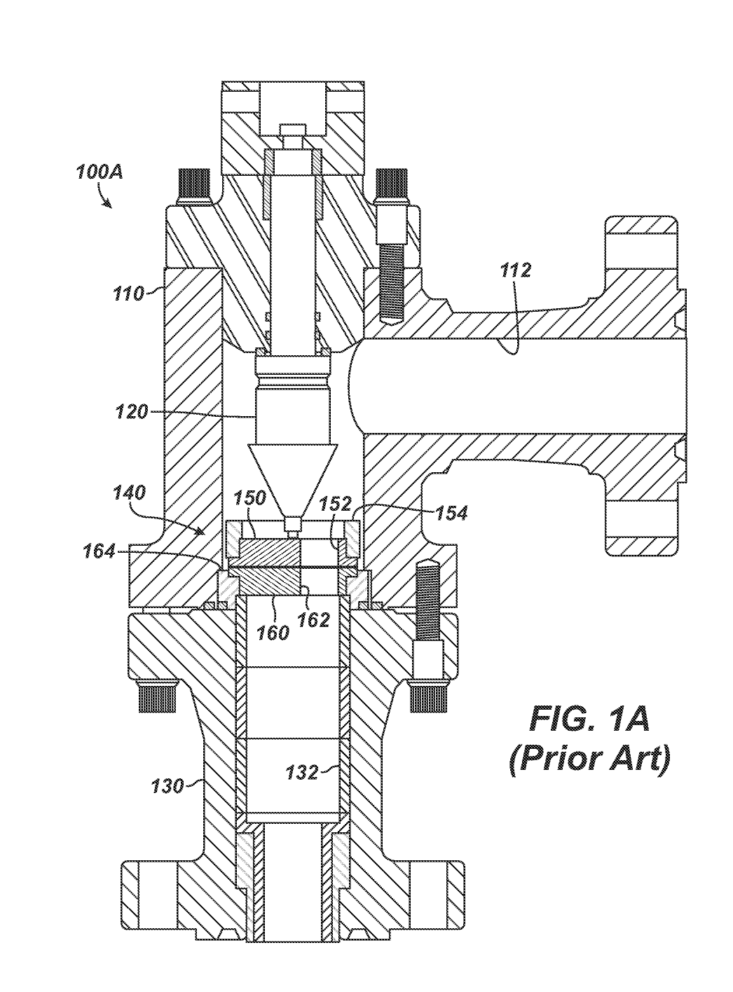

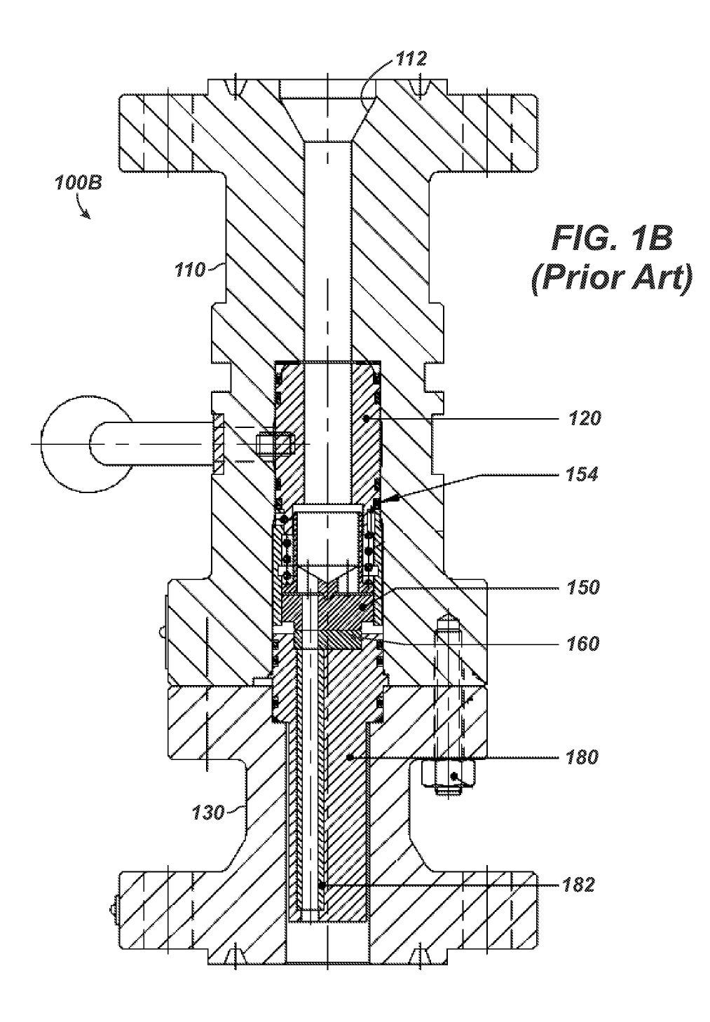

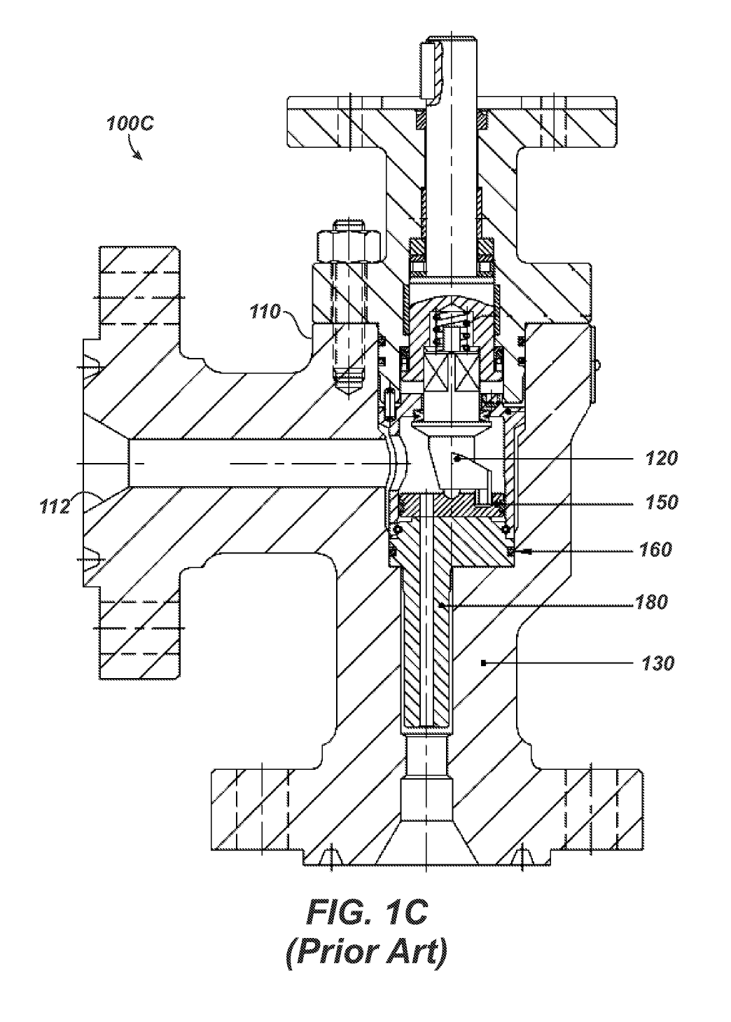

In addition to these advantages, features of the discs 300/400 discussed in more detail below can eliminate the need for all or most of the tungsten carbide liners typically required for the outlet spool (see e.g., inserts 132 in FIG. 1A). Moreover, these disc features help avoid the need for having long, expensive beans as used in some prior art arrangements of drilling chokes.

During operation of the choke 200, high velocity and abrasive drilling fluid passes through inlet conduit 212 into the choke's housing 210 and passes the throttling stem 220 holding the discs 300/400 together against lower holder 270. The throttling stem 220 operated either manually or automatically rotates the front disc 300 relative to the back disc 400 and determines the orifice size through the bores 310/410, thereby throttling the flow of drilling fluid through the choke 200.

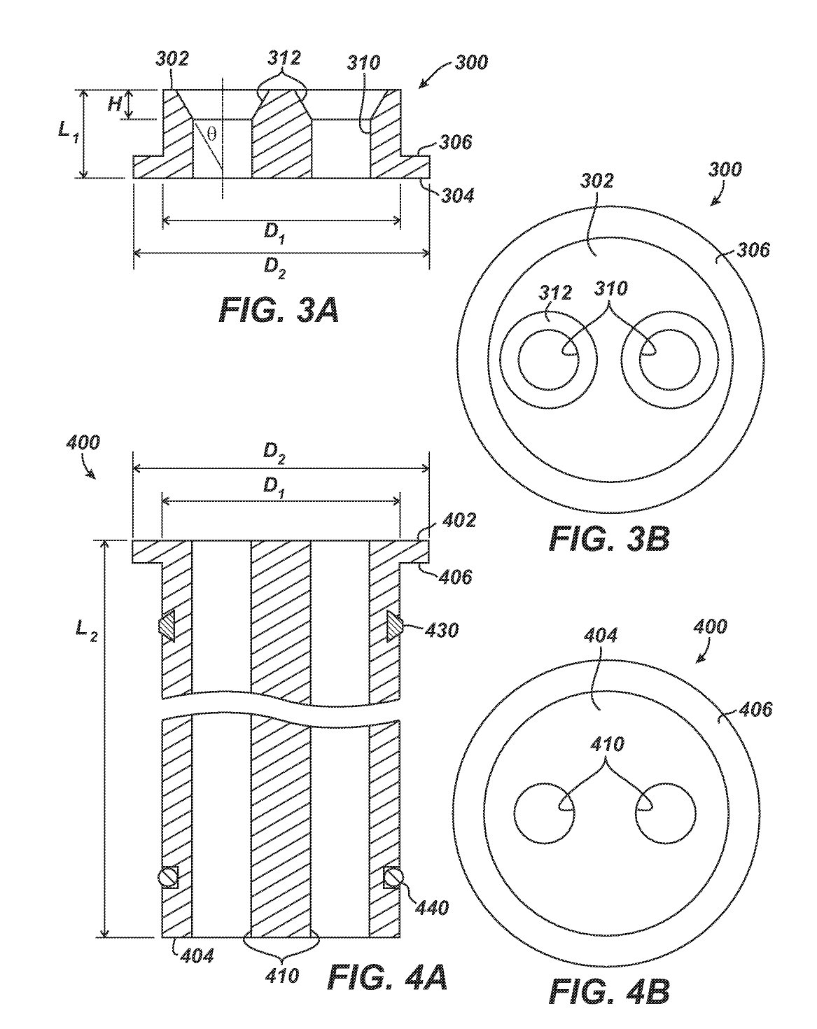

The rotatable front disc 300 shown in detail in FIGS. 3A-3B defines a pair of bores 310 that permit fluid flow through the disc 300. Each bore 310 defines a tapered relief 312 at the disc's front face 302. On the disc's back face 304, a circumferential rim 304 extends out from the disc 300 for positioning against the upper disc holder (260; FIG. 2). Similarly, the stationary back disc 400 shown in detailed in FIGS. 4A-4B defines a pair of bores 410 therethrough that permit fluid flow through the disc 400. Likewise, the disc's front face 402 has a circumferential rim 406 that positions against the lower holder (270; FIG. 2).

In general, the discs 300/400 can be composed of a metallic material, non-metallic, or ceramic material and, for example, can be composed of tungsten carbide. In addition, the front and back discs 300/400 both have the same diameter D₁, although this may not be strictly necessary in some implementations. As opposed to the conventional disc arrangements, the back disc 400 has a length L₂ that is greater than the front disc 300's length L₁. For example, the back disc 400's length L₂ can be at least twice that of the front disc 300. In this way, the back disc 400's length L₂ can be at least approximately 6/10^{ths} of its diameter D₁, while the front disc 300's length L₁ can be at least approximately 3/10^{ths} of the diameter D₁. Alternatively, the back disc 400's length L₂ can be even greater. For example, the entire length of the front and back discs 300/400 combined can be about at least 6 times the diameter of the chokes bore.

On the front disc 300, the tapered reliefs 312 in the bores 310 can define an angle θ relative to an axis through the bores 310, and the tapered reliefs 312 can extend a distance H in the bores 310. The relative dimensions of the discs 300/400, bores 310/410, and reliefs 312 may vary depending on the implementation, the size of the choke 200, the type of medium and flow rates expected, etc.

In one particular example, the front and back disc's diameter D₁ can be 4-inches, but it is understood that this dimension as well as the other dimensions discussed in the example herein depend on the choke or vale bore size, body cavity, flow medium, desired flow restriction, etc. Continuing with this example, the rims 306/406 can extend to a diameter D₂of about 5-inches. Each of the bores 310/410 can be about 1-inch in diameter, but in general can be of any diameter from about 0.125 or greater. The front disc 300's length L₁ can be 1.5-inches (i.e., 3/10^{th} of the disc's diameter D₁), while the back disc 400's length L₁ can be about 3-inches or greater (i.e., two times or greater than that of the front disc 300). In this example, the angle θ for the tapered reliefs 312 can be about 30-degree angle plus or minus and can extend the distance H of about 0.5-inches into the bores 310 (i.e., about one-third of the front disc 300's length L₁). Again, each of these dimensions is provided for illustrative purposes and actual values can depend on the particular implementation and other factors. Moreover, each of these dimensions can vary plus or minus within acceptable tolerances.

When the discs 300/400 are used to throttle drilling fluid through the choke 200, the front disc's tapered reliefs 312 help to funnel the high velocity and abrasive drilling fluid into the bores 310 and helps minimize material erosion by allowing the drilling fluid to enter the bores 310 at an angle rather than at a sharp edge. The stationary disc 400's increased length L₂ extends the bores 410 and minimizes the exiting angle of the fluid flow from the back face 404, thus reducing the flow energy and turbulence produced in the housing (210; FIG. 2) beyond the disc 400. In this way, most—if not all—of the costly carbide inserts in the exit spool (230; FIG. 2) may not be needed because the reduced flow energy and turbulence can help minimize body erosion caused by cavitations and abrasion. This reduced flow energy and turbulence can also reduce erosion to equipment downstream of the choke 200.

Although the front and back discs 300/400 have been disclosed as having a pair of bores 310/410 each, it will be appreciated that other implementations may use discs 300/400 having one bore, a pair of bores, or more than two bores in both discs 300/400 or that one disc may have more or less bores than the other disc. Although the front and back discs 300/400 have been disclosed for use in a drilling choke 200, it will be appreciated that the discs can be used in any application where rotating discs are used to throttle a medium through any various type of choke or valve, including, but not limited to, drilling or production chokes or valves. Within the choke 200 itself, other devices such as a cylindrical throttling member that engages outer edges of the rotatable disc 300 can be used for rotating the disc 300 as opposed to the throttling stem 220 described above that engages the disc 300's center. In addition, the throttling stem 220 of FIG. 2 can include a forked knuckle (not shown) that engages an outer region of the rotatable disc 300 or its holder 260 facilitating rotation of the front disc 300 by the stem 220.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A flow adjusting apparatus, comprising:
a first disc fixedly positionable in a housing flow passage, the first disc having a front face and a back face, the first disc defining at least one first bore from the front face to the back face permitting fluid flow through the first disc; and
a second disc rotatably positionable in the housing flow passage, the second disc having a front face and a back face, the back face positioning adjacent the front face of the first disc, the second disc defining at least one second bore from the front face to the back face permitting fluid flow through the second disc, the at least one second bore defining a tapered relief at the front face, the second disc being rotatable relative to the first disc and adjusting relative orientation between the first and second bores, whereby the relative orientation adjusts fluid flow through the first and second discs.

2. The apparatus of claim 1, wherein the first disc has a first length that is greater than a second length of the second disc.

3. The apparatus of claim 1, wherein the first disc has a diameter that is the same as the second disc, wherein the first length is approximately 3/10ths of the diameter of the first disc, and wherein the second length is at least approximately 6/10ths of the diameter.

4. The apparatus of claim 1, wherein the tapered relief in the at least one second bore defines an angle relative to an axis through the at least one second bore.

5. The apparatus of claim 1, wherein the tapered relief extends a distance in the at least one second bore that is about one-third of a length of the second disc.

6. The apparatus of claim 1, wherein the first and second discs comprise a metallic, non-metallic, or ceramic material.

7. The apparatus of claim 1, wherein the first disc comprises a pair of the at least one first bores, and wherein the second disc comprises a pair of the at least one second bores alignable with the first bores.

8. The apparatus of claim 1, wherein the first disc comprises at least one seal disposed about the first disc and engageable with the housing flow passage.

9. A flow adjusting apparatus, comprising:
a housing having a flow passage;
a stationary disc fixedly positioned in the flow passage, the stationary disc having a front face and a back face, the stationary disc defining at least one first bore from the front face to the back face permitting fluid flow through the stationary disc; and
a rotatable disc positioned in the flow passage, the rotatable disc having a front face and a back face, the back face positioning adjacent the front face of the stationary disc, the rotatable disc defining at least one second bore from the front face to the back face permitting fluid flow through the rotatable disc, the at least one second bore defining a tapered relief at the front face,
wherein rotation of the rotatable disc adjusts relative orientation between the first and second bores and adjusts fluid flow through the discs.

10. The apparatus of claim 9, wherein the first disc has a first length that is greater than a second length of the second disc.

11. The apparatus of claim 9, wherein the first disc has a diameter that is the same as the second disc, wherein the first length is approximately 3/20ths of the diameter of the first disc, and wherein the second length is at least approximately 6/20ths of the diameter.

12. The apparatus of claim 9, wherein the tapered relief in the at least one second bore defines an angle relative to an axis through the at least one second bore.

13. The apparatus of claim 9, wherein the tapered relief extends a distance in the at least one second bore that is one-third of a length of the second disc.

14. The apparatus of claim 9, wherein the first and second discs comprise metallic, non-metallic, or ceramic material.

15. The apparatus of claim 9, wherein the first disc comprises a pair of the at least one first bores, and wherein the second disc comprises a pair of the at least one second bores alignable with the first bores.

16. The apparatus of claim 9, wherein the stationary disc comprises at least one seal disposed about the stationary disc and engageable with the flow passage.

17. A choke, comprising:
a housing having an inlet and an outlet and having a housing flow passage from the inlet to the outlet;
a throttling stem positioned in the flow passage, the stem having a proximate end coupled to the housing and having a distal end disposed in the flow passage;
a stationary disc fixedly positioned in the housing flow passage, the stationary disc having a front face and a back face, the stationary disc defining at least one first bore from the front face to the back face permitting fluid flow through the stationary disc; and
a rotatable disc rotatably positioned in the housing flow passage between the stationary disc and the distal end of the stem, the rotatable disc having a front face and a back face, the back face positioning adjacent the front face of the stationary disc, the rotatable disc defining at least one second bore from the front face to the back face permitting fluid flow through the rotatable disc, the at least one second bore defining a tapered relief at the front face,
wherein rotation of the rotatable disc adjusts relative orientation between the first and second bores and adjusts fluid flow through the discs.

18. The choke of claim 17, wherein the stationary disc has a first length that is greater than a second length of the rotatable disc.

19. The choke of claim 17, wherein the first disc has a diameter that is the same as the second disc.

20. The choke of claim 17, wherein the tapered relief in the at least one second bore defines an angle relative to an axis through the at least one second bore.

21. The choke of claim 17, wherein the tapered relief extends a distance in the at least one second bore that is one-third of a length of the second disc.

22. The choke of claim 17, wherein the first and second discs comprise metallic, non-metallic, or ceramic material.

23. The choke of claim 17, wherein the first disc comprises a pair of the at least one first bores, and wherein the second disc comprises a pair of the at least one second bores alignable with the first bores.

24. The choke of claim 17, wherein the stationary disc comprises at least one seal disposed about the stationary disc and engageable with the flow passage.
